(19) United States
(12) Patent Application Publication
(10) Pub. No.: US 2006/0026583 A1
(43) Pub. Date: Feb. 2, 2006

(54) Systems and methods for providing complex software

(76) Inventors: Juergen Remmel, Muehlhausen (DE); Andreas S. Schmitt, Kaiserslauten (DE); Frank Stephan, Luedenscheid (DE); Christian M. Taut, Mannheim (DE); Michael R. Franz, Singheim (DE); Stefan Weisenberger, Heidelberg (DE); Michael M.A. Acker, Grossfischlingen (DE); Yvonne Sander, Bad Schoenborn (DE); Veronika Schmid-Lutz, Ittlingen (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/060,741

(22) Filed: Feb. 18, 2005

Related U.S. Application Data
(60) Provisional application No. 60/591,120, filed on Jul. 27, 2004.
(60) Provisional application No. 60/591,112, filed on Jul. 27, 2004.

(51) Int. Cl. G06F 9/44

(52) U.S. Cl. 717/162; 717/140

(57) ABSTRACT

Systems and methods are provided for configuring and executing complex software. The complex software may include code corresponding to a core layer and code corresponding to at least one of a plurality of industry extensions. A method for configuring software is provided that includes presenting at least one business set for selection by the user. The method further includes receiving a selection of at least one business set from the user, and receiving a selection of functions from the user based on the selected business set. The method further includes determining whether the selection of functions by the user is valid, and activating switches to enable software elements corresponding to the selected functions, if the user selection of the functions is determined to be valid.

### CROSS REFERENCE TO RELATED APPLICATIONS

This application claims priority under 35 U.S.C. § 119 to U.S. Provisional Application Nos. 60/591,120, filed Jul. 27, 2004 and 60/591,112, filed Jul. 27, 2004, both of which are expressly incorporated herein by reference in their entirety. This application also claims priority to U.S. application Ser. No. 10/845,184, filed May 14, 2004, which is also expressly incorporated herein by reference in its entirety.

### BACKGROUND INFORMATION

1. Field of the Invention

The present invention generally relates to software and to systems and methods for providing and/or distributing software, including complex software. More particularly, the invention relates to systems and methods for providing complex software.

2. Background of the Invention

In today's marketplace, software developers and vendors offer various types of applications and programs to members of the public. Software applications and programs are often designed with a specific set of functionality and offered as a complete package. Many times, users are faced with the dilemma of selecting software that best fits their needs. In some cases, a certain application or program may include more components or functions than are required by the user. In other cases, a particular software program may not have all of the required functionality and, as a result, the user may be forced to purchase more than one application in order to fulfill his or her needs.

Customizing complex software for users creates problems, such as conflicts between selected functions or components. For example, two different functions may attempt to modify the same data or information at the same time and thus create problems with data integrity. Further, different functions may cause problems in terms of the screen layout or usability of graphical user interface(s).

Moreover, traditionally, software aimed at providing business processing functionality to various industries has been created and sold as separate industry solution packages. Thus, for example, there might be separate software packages for different industries, such as oil, automotive, travel and/or other industries. Accordingly, non-industry specific changes in software have to be made in the various different industry packages causing significant amount of effort for the software developer.

Accordingly, in view of the foregoing, there is a need for systems and methods for providing software that overcomes one or more of the above-noted problems and/or disadvantages.

### SUMMARY OF THE INVENTION

Embodiments consistent with the present invention provide systems and methods for providing software, configuring software, and/or executing software. In accordance with one aspect of the invention, the software may correspond to any type of application or package, including complex software packages.

According to one embodiment of the invention, a method for configuring software is provided, where the software may comprise a core and a plurality of user selectable functions. The method may include presenting at least one business set for selection by a user and, in response thereto, receiving a selection of at least one business set from the user. The method may further include presenting a plurality of functions for selection by the user based on the selected business set, receiving a selection of functions from the user, and determining whether the user selection of functions is valid. Additionally, the method may include activating switches to enable software elements corresponding to the selected functions, if the user selection of the functions is determined to be valid.

According to another embodiment of the invention, a system for configuring software is provided, where the software may comprise a core and a plurality of user selectable functions. The system may include means for presenting at least one business set for selection by a user, each business set including a plurality of selectable functions, and means for receiving a selection of at least one business set from the user. The system may further include means for receiving a selection of functions from the user based on the selected business set and means for determining whether the user selection of functions is valid. Additionally, the system may further means for activating software elements corresponding to the selected functions, if the user selection of the functions is valid.

According to yet another embodiment of the invention, a method is provided for executing complex software, wherein the complex software comprises code corresponding to a core layer and code corresponding to at least one of a plurality of industry extensions. The method may include detecting, during execution of the code corresponding to the core layer, an enhancement object at a first location, wherein the enhancement object relates to one of the plurality of industry extensions, switching execution from the first location to a second location in code relating to the one of the plurality of industry extensions, and, depending on a type of the enhancement object, executing code corresponding to a code block at the second location along with the code corresponding to the core layer, or executing the code corresponding to the code block at the second location instead of at least a part of the code of the core layer.

According to still another embodiment of the invention, a method is provided for executing code corresponding to a core layer and code provided outside the core layer. The method may include detecting, during execution of the code corresponding to the core layer, an enhancement object at a first location, wherein detecting the enhancement object at the first location includes checking an external file, switching execution from the first location to a second location in the code outside the core layer, and, depending on a type of the enhancement object, executing code corresponding to a code block at the second location along with the code corresponding to the core layer, or executing the code corresponding to the code block at the second location instead of at least a part of the code of the core layer.

Additional objects and advantages of the various embodiments of the invention will be set forth in part in the description, or may be learned by practice of the invention. The objects and advantages of the embodiments of the invention will be realized and attained by means of the elements and combinations particularly pointed out in the appended claims.

The various embodiments can include and/or exclude different aspects, features and/or advantages, where applicable. In addition, various embodiments can combine one or more aspects or features of other embodiments, where applicable.

### BRIEF DESCRIPTION OF THE DRAWINGS

It is to be understood that both the foregoing general description and the following detailed description are exemplary and explanatory only and are not restrictive of the invention, as claimed. The accompanying drawings, which are incorporated in and constitute a part of this specification, illustrate several embodiments of the invention and together with the description, serve to explain the principles of the invention. In the drawings:

FIG. 1 is a block diagram of an exemplary software system that can be configured using extensions, consistent with an embodiment of the present invention;

FIG. 2 is a block diagram of exemplary business sets, consistent with an embodiment of the present invention;

FIG. 3 is a schematic diagram illustrating various types of business sets a user may select, consistent with an embodiment of the present invention;

FIGS. 4A and 4B illustrate exemplary interfaces for receiving user selections to configure software, consistent with embodiments of the present invention;

FIG. 5 is a flow chart of an exemplary method for offering software to a user, consistent with an embodiment of the present invention;

FIG. 6 is a block diagram illustrating an exemplary switch-based framework comprising business functions, switches, and user selectable software elements, consistent with an embodiment of the present invention;

FIG. 7 shows exemplary relationships between functions and software elements related to various industry solutions, consistent with an embodiment of the present invention;

FIGS. 8A, 8B, 8C, 8D, and 8E are block diagrams illustrating exemplary processes for providing and handling objects, such as enhancement objects, consistent with embodiments of the present invention;

FIG. 9 is a flow chart of an exemplary method for configuring software, consistent with an embodiment of the present invention;

FIG. 10 is a table showing exemplary relationships among enhancement objects, users, clients, user sets, and client sets, consistent with an embodiment of the invention; and

FIG. 11 is a flowchart of an exemplary method for generating complex software, consistent with an embodiment of the invention.

### DETAILED DESCRIPTION

The following detailed description of embodiments of the present invention refers to the accompanying drawings. Where appropriate, the same reference numbers in different drawings refer to the same or similar elements.

Systems and methods consistent with the present invention relate to providing software, configuring software, and/or executing software. As disclosed herein, embodiments of the invention may be implemented to offer various types of computerized systems or software, including complex software systems and programs. For example, in accordance with an embodiment of the invention, a complex software package may be offered that includes a core layer. The core layer may include core functions and features that can be combined with extensions, such as software extensions. Extensions may relate to sub-system and/or specific capabilities for an industry, such as banking and automotive, or may relate to additional functionality and/or features that are not otherwise provided by the core. By selectively activating the extensions, a software vendor or seller can configure a complex software system based on a user's specific needs. Activation of the selected extensions may result in relevant functionality and/or features (e.g., screen elements, menu screens, data fields, etc.) being automatically configured for the selected extensions.

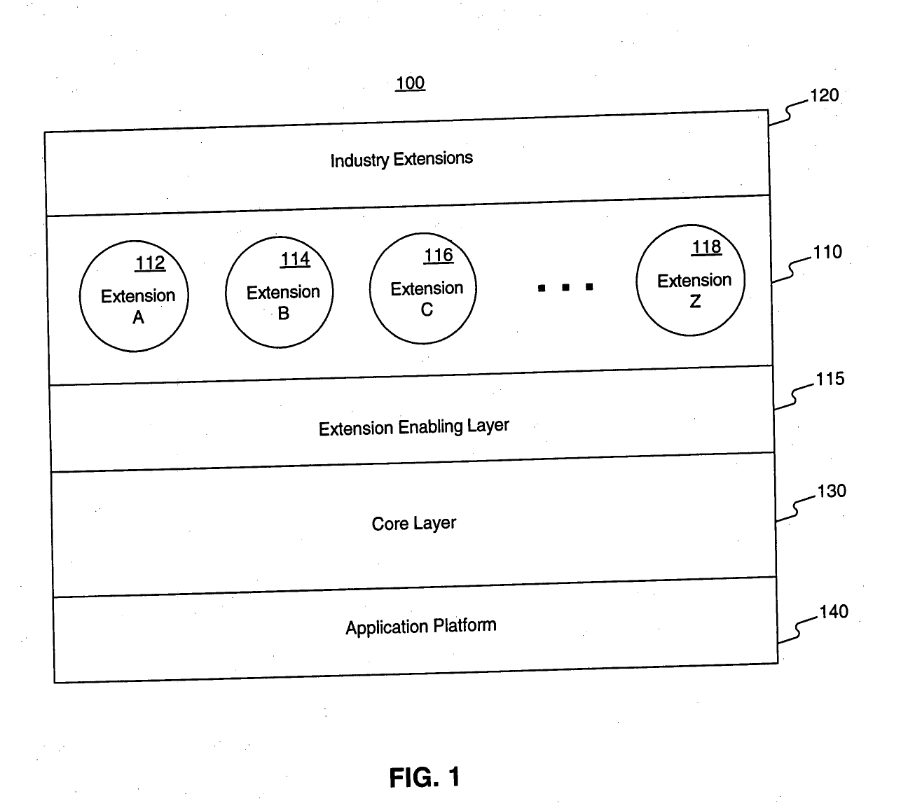

Referring to FIG. 1, a block diagram of an exemplary software system is shown, consistent with an embodiment of the invention. The example of FIG. 1 relates to a complex software system 100, such as an enterprise resource planning system or advanced planning system. As disclosed herein, software system 100 may be considered “complex” since it includes a number of software elements or components. These components are organized and illustrated as different layers in FIG. 1. As will be appreciated by those skilled in the art, embodiments of the invention are not limited to providing complex software (such as that illustrated in FIG. 1), but may also be applied for providing other types of software packages or systems.

As shown in FIG. 1, complex software system 100 may be provided that includes a set of extensions 110, a core layer 130, an extension enabling layer 115, an application platform 140, and industry extensions 120. In one embodiment, industry extensions 120 may represent extensions for specific industries and, unlike the set of extensions 110, may not be complete software packages. Instead, industry extensions 120 may be specific functionality or features (e.g., screen elements, menu screens, data fields, etc.) that modify, add, and/or delete aspects of extensions 110, for example. Alternatively, or additionally, industry extensions 120 may modify, add, and/or delete aspects of other layers of system 100, such as core layer 130 and application platform 140. Each extension may relate to a complete software package or set of functionality and/or features that can be combined with or modify the functionality and/or features of core layer 130. In one embodiment, extensions may relate to the SAP Enterprise Core Component (ECC) available from SAP AG (Walldorf, Germany).

Extension enabling layer 115 may facilitate the enablement of extensions 112-118 according to a user's selection. In addition, extension enabling layer 115 may record or track the extensions selected by a user. This may be achieved by, for example, a registration table or other database tables or storage means. Where appropriate, extension enabling layer may also evaluate a user selection to determine if a set of selected extensions is valid. In one embodiment, this may be achieved through software-based logic or an appropriate algorithm. Additionally or alternatively, the validity of selections may be determined by comparing a user selection to a look-up table or other storage means that indicates valid combinations of extensions. Whether or not a particular set of extensions is “valid” may rest upon on one or more factors, such as the interoperability or dependency of the extensions alone, in combination with other selected extension(s), and/or relative to other software layers (such as core layer 130). If a user selection is determined to be valid, extension enabling layer 115 may activate the selected extensions by including or enabling the same within the source code or compiled code delivered to the user. Further, any non-selected extensions may be left inactive or non-enabled in the software delivered to the user. In one embodiment, industry extensions 120 may represent extensions for specific industries and, unlike the set of extensions 110, may not be complete software packages. Instead, industry extensions 120 may be specific functionality or features (e.g., screen elements, menu screens, data fields, etc.) that modify, add, and/or delete aspects of extensions 110, for example. Alternatively, or additionally, industry extensions 120 may modify, add, and/or delete aspects of other layers of system 100, such as core layer 130 and application platform 140.

Core layer 130 may correspond to core software components or applications for complex software system 100. Core layer 130 may provide core functionality and/or features that are not particularized or embodied for any specific industry group, function group or custom group. Additionally, or alternatively, core layer 130 may include functionality that can be shared by extensions 112-118 of complex software system 100. By way of example, core layer 130 may be implemented with a core system such as the R/3 system, available from SAP AG (Walldorf, Germany).

Application platform 140 may comprise a software platform for supporting the various other layers of complex software system 100, including core layer 130. Such a software platform may comprise software (such as system operating software, portal software, database software, etc.) either alone or in combination with suitable hardware (such as a computing platform, a server, memory, etc.). In one embodiment, application platform 140 may include a web server, a business warehouse, and an enterprise portal. By way of example, application platform 140 may be implemented with SAP Netweaver, which is commercially available from SAP AG.

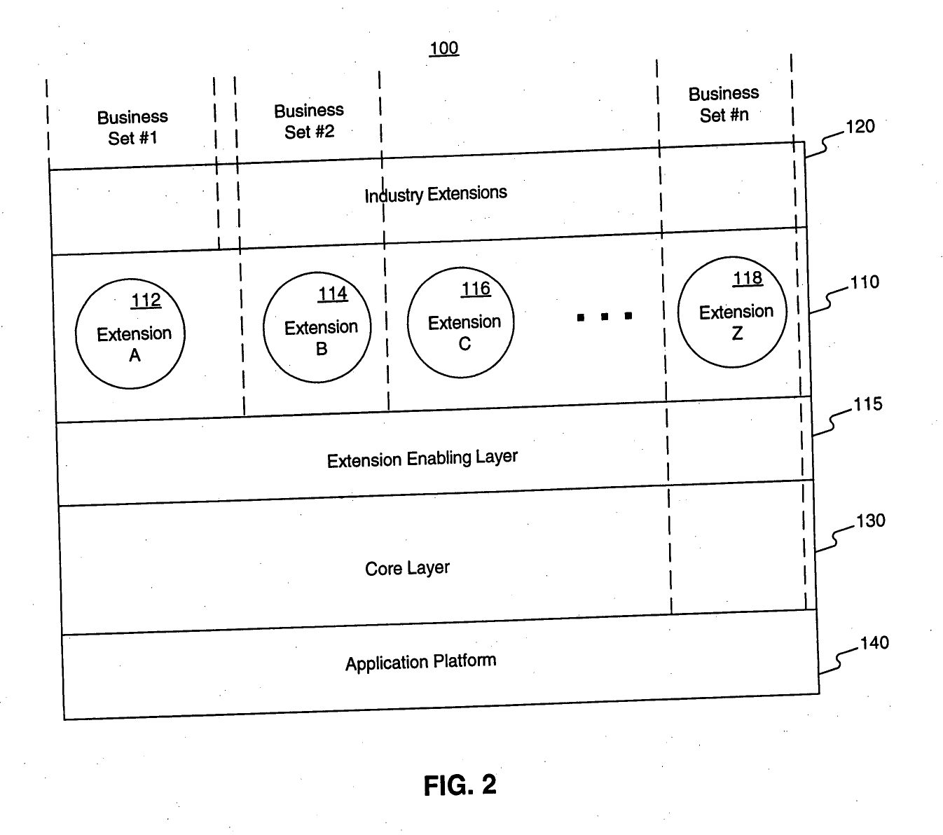

FIG. 2 is a block diagram of exemplary business sets, consistent with an embodiment of the present invention. In this figure, complex software system 100 is shown with a plurality of business sets #1-#n (represented by dashed-lines and superimposed on the layers for illustrative purposes). A business set may contain all functions related to particular offering to a customer. A business set may contain functions related to several different industry solutions. Additionally or alternatively, there may be several business sets corresponding to a particular industry, such as automotive. Business sets may represent sets of selectable functionality and/or features (e.g., screen elements, menu screens, data fields, etc.). The selectable functionality and/or features of the business sets (collectively referred below as “functions”) may extend to or impact on any combination functionality and/or features of one or more layers of system 100, including application layer 140, core layer 130, set of extensions 110, and/or industry extensions 120. As further disclosed herein, business sets may be defined by a software vendor according to industry groups, function groups and/or custom groups.

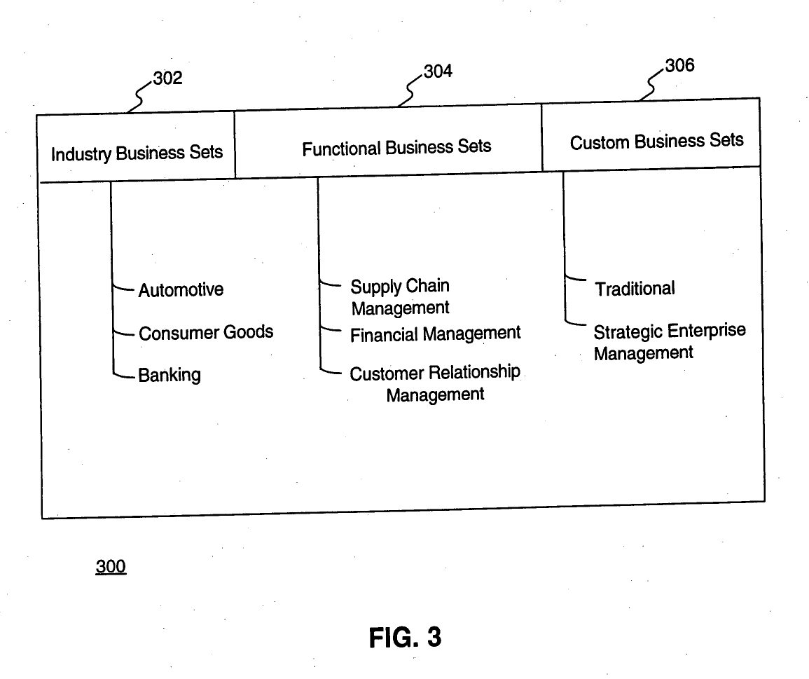

Business sets may comprise industry-specific business sets, functional business sets, and/or custom business sets (see, for example, FIG. 3). Industry business sets may relate to extensions for specific industry groups, such as automotive, consumer goods, or banking. Functional business sets may relate to extensions for specific functional groups, such as supply chain management, financial management, or customer relations management. Custom business sets may relate to custom configurations of complex software system 100, such as traditional or strategic enterprise management configurations.

In one embodiment, a user may select a business set, such as business set #1, business set #2, . . . or business set #n. Further, after a user selects a business set, then the user may select specific functionality and/or features that are grouped or associated with that selected business set. This approach can provide a controlled and/or guided process for user selection and, ultimately, configuration of the software.

As shown in FIG. 2, selected business sets and functions from that business set can result in modifications in one or more layers of system 100. Thus, if the user selects business set #1 and certain functions within that business set, functionality and/or features related to industry extensions 120 may be impacted (e.g., enabled and disabled). If the user selects business set #2 and certain functions within that business set, then modifications may result not only to industry extensions 120, but also to set of extensions 110 depending on the specific functions that are selected. As represented by business set #n in the example of FIG. 2, the user selection may also impact items and features further down in system 100, such as in core layer 130. Alternatively, it may be desirable that core layer 130 does not change regardless of what business sets and functions are selected.

FIG. 3 is a schematic diagram illustrating various types of business sets a user may select. As shown in the figure, using a pull down menu or some other graphical user interface element (provided by an extension enabling layer or similar logic, for example), a user may access and select functions (functionality and/or features) based on one or more groups of business sets, such as industry business sets 302, functional business sets 304, or custom business sets 306. Industry business sets 302 may relate to extensions for specific industry groups, such as automotive, oil and gas, consumer goods, or banking. Functional business sets 304 may relate to extensions for specific functional groups, such as supply chain management, financial management, or customer relationship management. Custom business sets 306 may relate to custom configurations of complex software system 100, such as traditional or strategic enterprise management. A business set from any of these groups of business sets may be selected by a user using any combination of graphical user interface elements, such as radio buttons, pull down lists, checkboxes, input/output fields, push buttons, tab-strip control, sub-screen area, table control, custom control, status icon, etc.

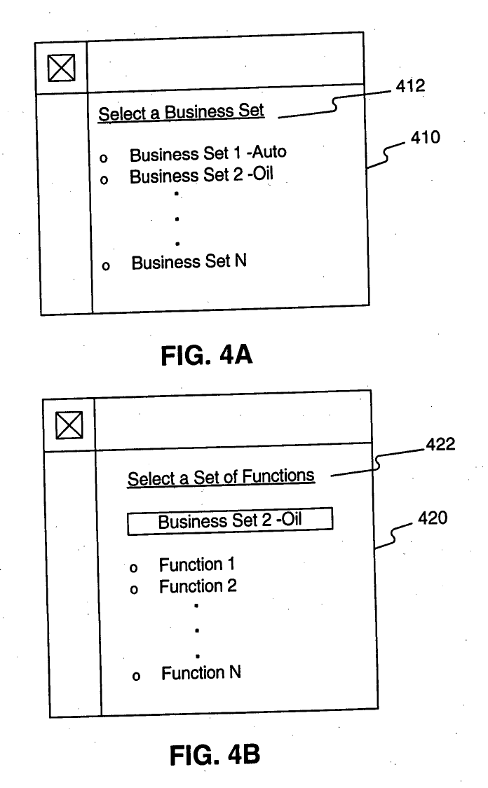

FIG. 4A shows an exemplary user interface 410 for selecting a business set, consistent with an embodiment of the invention. In this example, a single grouping of business sets are presented to the user, such as industry business sets including Business Set 1—Auto, Business Set 2—Oil, etc. By choosing an option under Select a Business Set 412, the user can select a specific business set. Descriptions for each of the presented business sets may be provided for the user to facilitate the selection. Descriptions may be displayed or otherwise provided through a link, a reply email or otherwise upon request.

As shown by the exemplary user interface 420 of FIG. 4B, once the user selects a business set (e.g., through an interface such as in FIG. 4A), the user may then select a set of functions associated with the selected business set. This may be achieved, for example, by choosing an option under Select a Set of Functions 422. For example, if the user selected a Business Set 2 related to the oil industry, a number of Functions 1,2, . . . n, may be listed for selection by the user. Depending on the user selection, the software may then be configured and offered to the user. Similar to the descriptions for the business sets, descriptions for functions may also be provided to aid the user in making his/her selection.

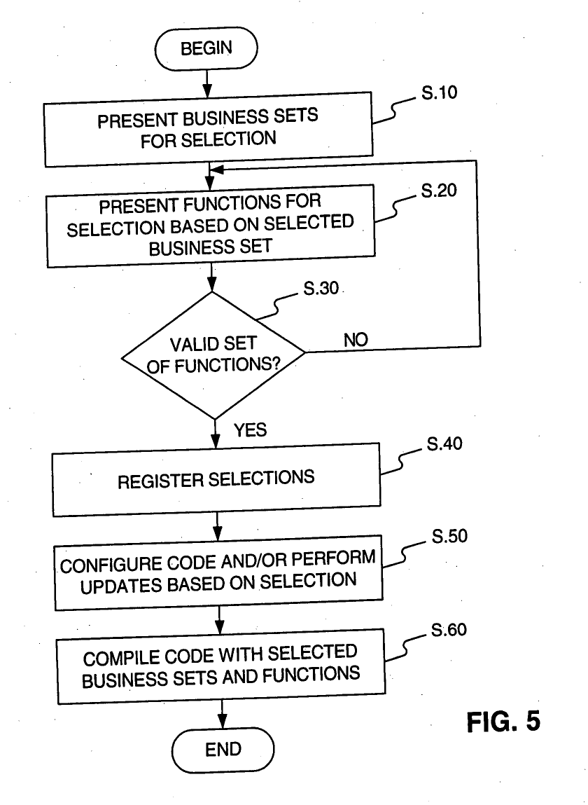

FIG. 5 is a flow chart of an exemplary method for configuring and offering software to a user, consistent with an embodiment of the present invention. The exemplary method of FIG. 5 may be applied to offer any type of computerized system or software, including complex software 100 of FIGS. 1 and 2. Further, in accordance with an aspect of the invention, the method of FIG. 5 may be automated by using a software component, such as extension enabling layer 115 and/or configuration module.

In step S.10, business sets may be presented to the user for selection. In one embodiment, a user may be presented the selection of business sets using a graphical user interface, such as interface 300 (FIG. 3) or interface 410 (FIG. 4A). Thus, the user may select a business set from groupings of industry business sets, functional business sets, or custom business sets (see, for example, FIG. 3). Alternatively, the user may be able to select a business set from a specific group of business sets, such as a business set for a group of industry business sets (see, for example, FIG. 4A).

Next, the user may be presented with a list of functions (functionality and/or features) for selection based on the selected business set (step S.20). Available selections may be presented using a graphical user interface, similar to exemplary user interface shown in FIG. 4B. One skilled in the art will appreciate that any graphical user interface and/or other techniques (e.g., email, orally via telephone, etc.) may be used to present functions for user selection.

Next, a configuration module or similar logic may determine whether the user selection of functions is valid (step S.30). In one embodiment, this step may include detecting any conflicts among the selected functions. Conflicts may be detected by applying logic or a suitable algorithm. In one embodiment, one or more tables may be accessed that indicate permissible combinations of functions. Conflicts between selected functions may relate to, for example, incompatible or unsupported combinations of functions or logic. Invalid function selections may also arise if it is determined that any two selected functions may result in, for example, attempts to modify or call the same data or system components at substantially the same time. In one embodiment, such conflicts may be known or determined based on the analysis of various configurations of industry extensions 120, etc.

If the selection of functions is determined not to be valid (step S.30; No), then the process may return to step S.20 where the user is again prompted to make a selection. As part of this step, the user may be informed of his/her selection was determined to be invalid. Additionally, or alternatively, in one embodiment, at least one alternative or additional function may be proposed to the user, such that the conflict among the functions can be resolved by selecting that function.

If the user selection is determined to be valid (step S.30; Yes), then processing may continue. In step S.40, the user-selected business set and functions may be registered or otherwise recorded. In one embodiment, the user-selected business set and functions may be registered with a reporting agent, which may keep track of the user-selected business sets and functions. In another embodiment, step S.40 is made optional or completely eliminated form the overall process of FIG. 5.

In step S.50, a configuration module or similar logic may configure and/or perform updates to the source code based on the user-selected business set and combination of functions. Thus, for example, tables and/or other data storage elements may be updated to configure the original source code according to the user selections. Such updates may be made to activate the functionality and/or features selected by the user. As described above, updates may be required throughout the code for one or more layers of the complex software system 100.

Thereafter, in step S.60, the configured source code may be compiled to generate a user-specific system. In one embodiment, only the selected functionality and/or features may be operable and the remaining functions may not be made operable in the software shipped to the user. Thus, once configured and shipped to the user, the user may not access or use unselected functionality or features. In such case, a configuration module or other logic may keep track of unselected and selected functions and prevent the user from accessing certain functionality and/or features.

In accordance with one embodiment of the invention, a user may be permitted to change the selection of functions after delivery of the software. For example, after the user-specific system has been shipped to the user, the user may be able to request additional functions from a business set. For this purpose, the reporting agent may keep track of such requests and based on a pre-agreed policy, the source code may be reconfigured and compiled so that the newly selected functions are activated.

In the above-described embodiments, business sets may be mutually exclusive. That is, the user may only select one business set at any given time. This can result in greater control over the selection process and provide greater stability for the core and other layers of system 100. Alternatively, the user may be permitted to select more than one business set. In such a case, the validity of the combination of business sets selected may be determined, in a similar fashion to that described for checking the validity of selected functions.

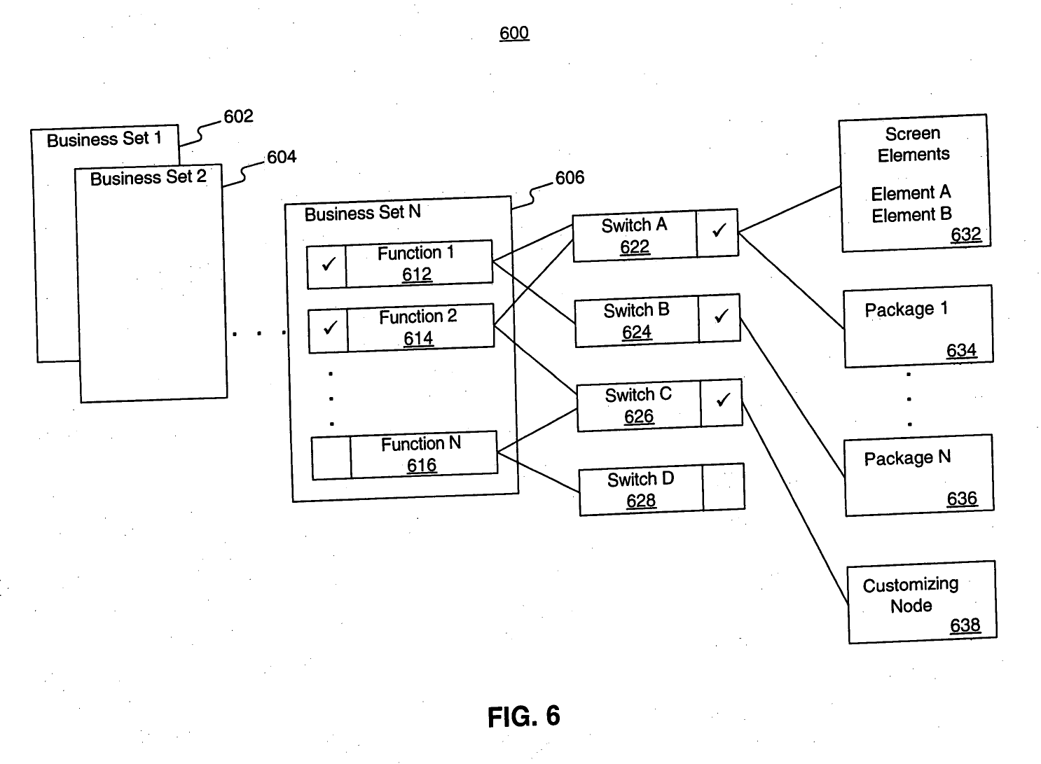

Consistent with an aspect of the present invention, switches may be utilized to facilitate the activation of user-selected functions. Such switches may be implemented with software and/or other means (e.g., software objects and database entries) to provide an automated framework for selectively activating functions. By way of example, FIG. 6 is a block diagram of an exemplary switch-based framework 600. As illustrated, framework 600 comprises a plurality of switches 622-628. Each of the switches may have a predetermined relationship or dependency with one or more functions associated with a business set. In the example of FIG. 6, a plurality of business sets 602-606 is shown. These business sets (i.e., Business Set 1 602, Business Set 2 604, and Business Set N 606) may be implemented as any type of business set or grouping of functions, such as that discussed above with respect to FIGS. 1-5. In one embodiment, each business set includes one or more functions. For example, Business Set N 606 may include Function 1 612, Function 2 614, and Function N 616.

As discussed earlier, with respect to FIGS. 1-5, a user may select any of the functions corresponding to a selected business set. Thus, in the example of FIG. 6, Function 1 612 and Function 2 614 are shown as being selected by the user, but Function N 616 is not selected. If a valid combination of functions are determined to be selected by the user, then the corresponding switch or switches may be activated to implement the necessary functionality and/or features. The relationships or dependencies between the functions and switches may be managed using database tables, object oriented programming techniques, and/or other information relationship management techniques. By way of an non-limiting example, as shown in FIG. 6, if Function 1 612 is selected by the user, that may result in the activation of Switch A 622 and Switch B 624. Further, if Function 2 614 is selected by the user, then that may result in activation of Switch A 622 and Switch C 626. Furthermore, since Function N 1 616 is not selected, Switch D 628 is not activated. While FIG. 6 shows only one level of relationships, the relationships between functions and switches may be multi-level.

As further shown in FIG. 6, relationships or dependencies may also exist between the switches 622-628 and one or more software elements 632-638. As before, such dependencies may be managed using database tables, object oriented programming techniques, etc. Software elements corresponding to the switches may include, for example, screen elements, packages of code, customizing nodes, configuration files, and/or any other software elements necessary for configuring, executing, or otherwise implementing the necessary functionality and/or features based on the user-selected functions. Consistent with an aspect of the invention, when a switch is activated based on the selection of a function by a user, the activation of that switch may cause the corresponding or related software elements to be enabled. As disclosed herein, switches corresponding to the selected function may be automatically turned on by software used for implementing the automated switching framework. Thus, for example, when Switch A 622 is turned on, Screen Elements 632 (e.g., Element A and Element B) and Package 1 634 may be enabled. Similarly, when Switch B 624 and Switch C 626 are turned on, Package N 636 and Customizing Node 638 may be enabled. In one embodiment, Customizing Node 638 may provide automatic or manual customization of a particular aspect of the software. Customizing node may be active only when a user selects a particular function. For example, if the function relates to an automotive industry solution, then a particular aspect of the software may need additional customization. However, if the function relates to an oil industry solution, then there may not be any need for customization of the particular function.

Packages 634-636 may comprise one or more objects. In one embodiment, packages may be implemented as object containers. Objects may include, blocks of coding, functional modules, appends, transaction codes (e.g., codes or identifiers to call a sub-routine), business add-ins, transactions, reports, database tables, and/or other software components. Appends may relate to fields, for example, which could be added to an existing database structure. Business add-ins may relate to additional business code that will be processed as part of the processing of the selected business set. Transactions may relate to any financial transaction, such as a purchase order, which may be processed as part of the processing of the selected business set. In one embodiment, an activated switch may result in compilation of code or code blocks corresponding to the activated switch, with the code for the core layer 130 of FIG. 1, for example. Alternatively, all code associated with all functions with all selected business sets may be compiled along with the code for the core layer, but executed based on whether a particular execution switch is activated.

As disclosed herein, each activated switch may cause its respective dependent software elements (e.g., screen elements, packages, customizing nodes, etc.) to be enabled. This, in turn, will cause the user-selected functions (i.e., functionality and/or features) to be implemented during execution of the software system. Further, within a package, only certain objects may react directly to an activated switch. Other objects may exist, but only react during run-time when other dependencies are true (i.e., the function module exists, but only reacts if, for example, it is called during run-time).

Consistent with an aspect of the invention, one or more software elements may be grouped to provide industry extensions that are selectable by a user. Each industry extension may relate to functions of one or more business sets. Such a relationship or dependency may be mapped using, for example, a switch-based framework like that presented in FIG. 6.

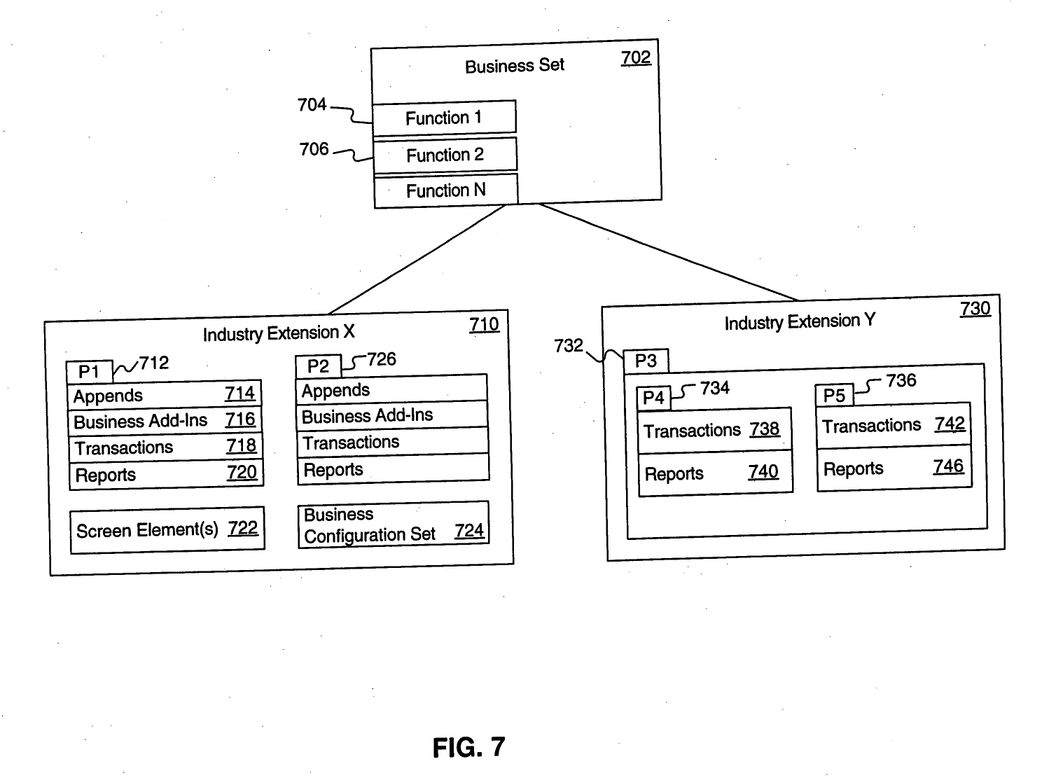

By way of example, FIG. 7 shows exemplary dependencies between functions of a business set and industry extensions. In particular, an exemplary Business Set 702 is illustrated that may include one or more functions, such as Function 1 704 and Function 2 706. Each of these functions may be mapped (e.g., using a switch-based framework) to one or more industry extensions. Alternatively, or additionally, any of these functions may be mapped to one or more software elements of one or more industry extensions. In the example of FIG. 7, two industry extensions are shown, namely Industry Extension X 710 and Industry Extension Y 730. Industry extension X 710 may include one or more software elements, such as Package P1 712 and Package P2 726. As disclosed herein, each package may include one or more components or objects. For instance, Package P1 712 may include software components or objects such as Appends 714, Business Add-ins 716, Transactions 718, and Reports 720. Industry Extension X 710 may also include other software elements, such as Screen element(s) 722 and Business Configuration Set 724. Screen element 722 may enhance or modify one or more user interfaces associated with the functions of Business Set 702. Industry extension X 710 may further include other packages, such as Package P2 726. Package P2 726 may include objects similar to that of Package P1 712.

Business Set 702 may further include mapping(s) to Industry Extension Y 730. Industry Extension Y 730 may include one or more software elements, such as Package P3 732. Package P3 732 may further include sub-packages, such as sub-package P4 734 and sub-package P5 736.

In one embodiment, one package and/or sub-package of an industry extension may not be assigned to different switches. But, one switch may be assigned to different packages or sub-packages. In addition, if a package is assigned to a switch, then the inner sub-package must not be assigned to another switch. In one embodiment, the automated switch framework, or similar software, may check the switch assignments and give an error message if a developer of the software, for example, makes an incorrect switch assignment.

Referring again to FIG. 7, sub-package P4 734 may further include objects, such as Transactions 738 and Reports 740. Further, sub package P5 736 may also include one or more objects or components, such as Transactions 742 and Reports 746.

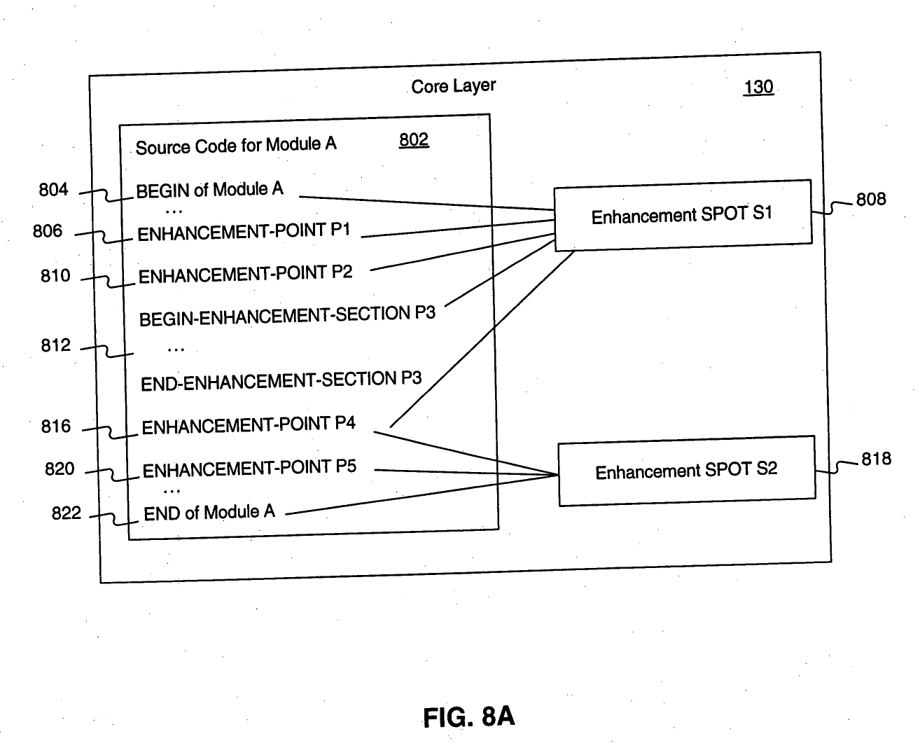

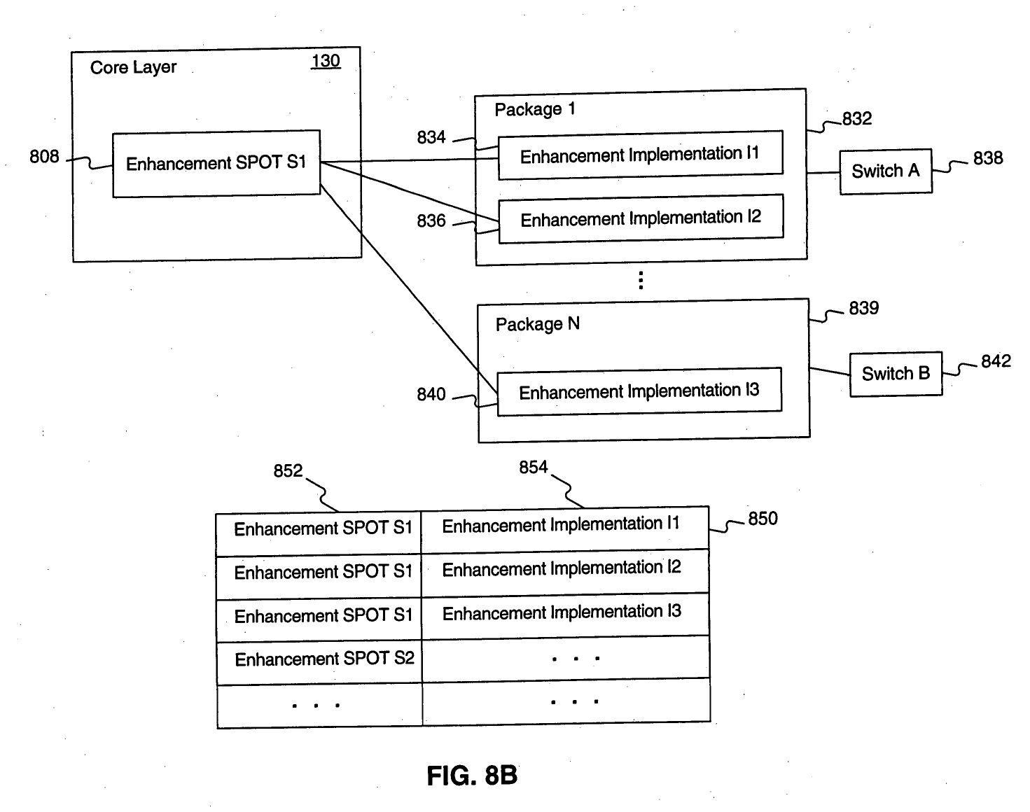

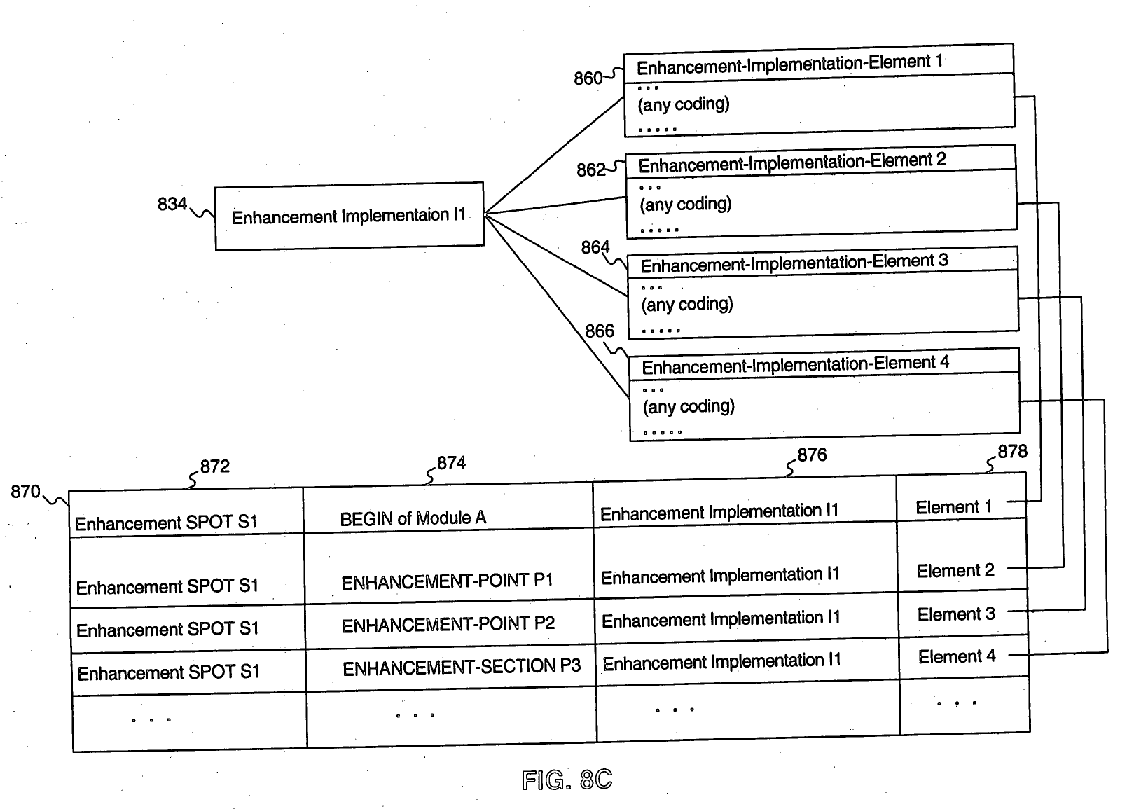

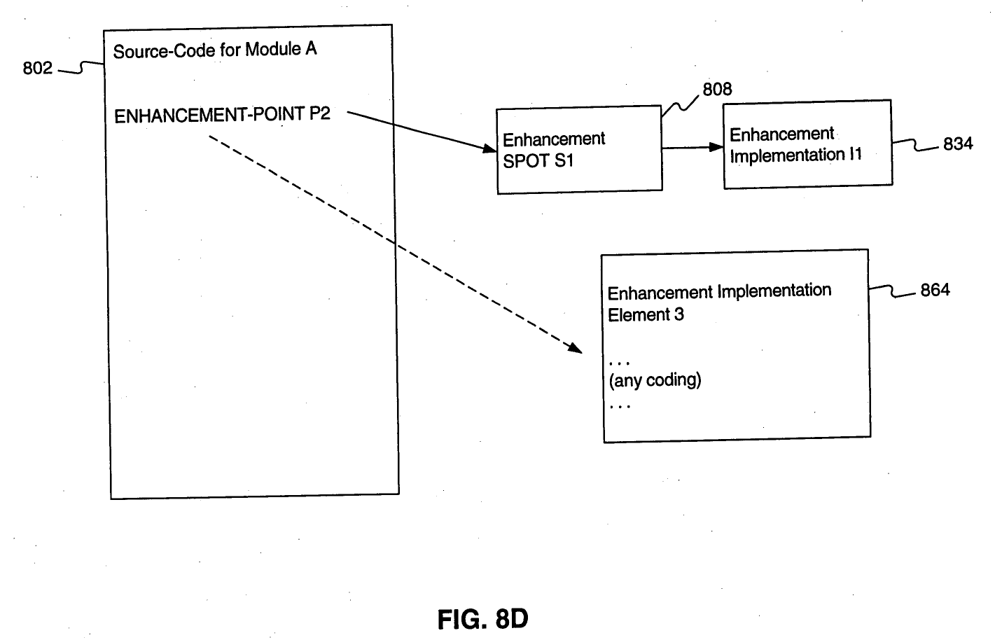

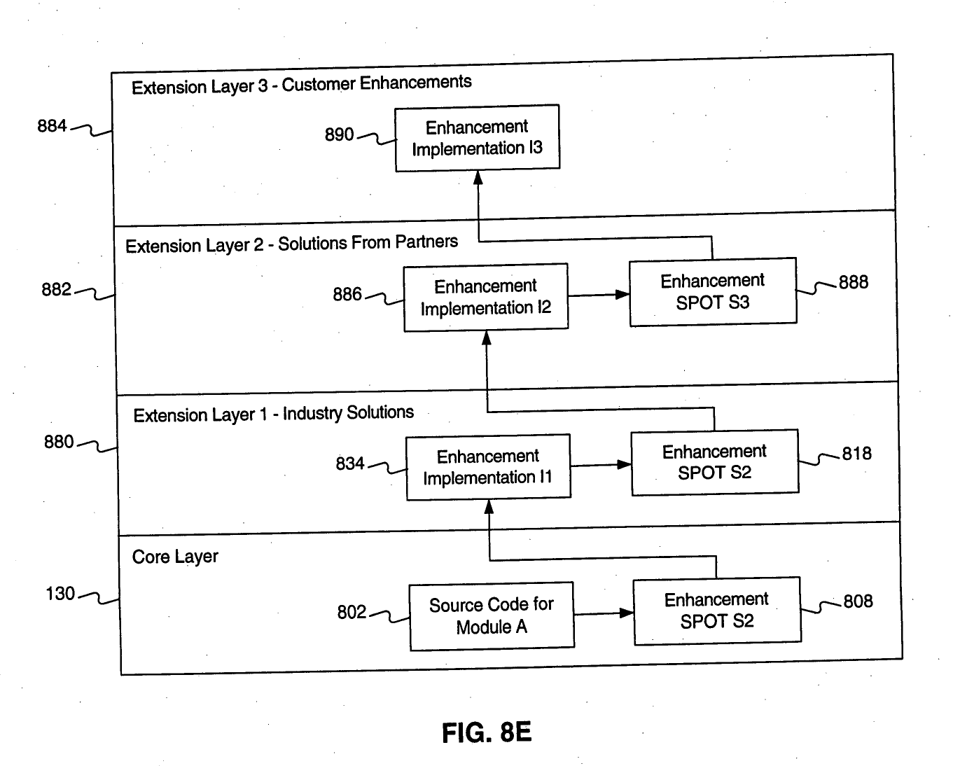

FIGS. 8A, 8B, 8C, 8D, and 8E are block diagrams illustrating exemplary processes for providing and handling objects, such as enhancement objects. Consistent with an aspect of the invention, enhancement objects may be provided to enhance or extend the code corresponding to a core or core layer of a software system, such as core layer 130. Enhancement objects may be implemented as a software mechanism to modify the code of the core consistent with the functions selected by a user (e.g., the selected functions of a business set). As disclosed herein, such enhancements may be achieved by the addition of data declarations or operational statements to the core layer code, or by the replacement of data declarations or operational statements in the core layer code. By way of example, enhancement objects may provide information concerning code or data declarations corresponding to code blocks that may either be complied or executed along with the core code or code corresponding to code blocks that may be executed instead of a particular code block or part in the core layer. Examples of enhancement objects include enhancement points and enhancement sections. In particular, code or data declarations that are compiled and/or executed along with core code may be delineated by statements in the code corresponding to the core layer and the package. Such statements may be referred to as an “enhancement point.” In contrast, code or data declarations that are compiled and/or executed instead of a particular code block in the core layer may be identified by an “enhancement section.” Consistent with an embodiment of the invention, one or more enhancement points may be combined alone or in combination with one or more enhancement sections to define “enhancement spots,” as further described below.

Referring now to FIG. 8A, an exemplary process for providing and handling enhancement objects is illustrated. As shown in FIG. 8A, core layer 130 may include source code for a program or module, such as source code for module A 802. To permit enhancements, one or more enhancement objects may be explicitly included in the source code. For example, in FIG. 8A, a number of enhancement objects are provided. The enhancement objects include enhancement points 806, 810, 816 and 820, and the enhancement section includes the enhancement section 812. Such enhancement objects may be provided throughout the source code for Module A 802 and/or other parts of the core layer. An enhancement point may be explicitly defined in the source code by using a unique statement, such as an identifier, name, code or ID. For instance, enhancement point 806 is defined in the example of FIG. 8A as “ENHANCEMENT-POINT P1.” An enhancement section may be explicitly provided to define a section or block of the source code in the core. Enhancement sections may be implemented by providing unique statements in the source code. For instance, enhancement section 812 is defined through the statements “BEGIN-ENHANCEMENT-SECTION P3” and “END-ENHANCEMENT-SECTION P3.” As will be appreciated by those skilled in the art, the above are merely examples and any suitable form of statements or declarations may be used to define enhancement points and sections in the core.

Consistent with an embodiment of the invention, enhancement objects may also be provided implicitly. For example, an existing source code statement such as “BEGIN of Module A” 804, which indicates the beginning of the source code for program module A 802, may used be as an implicit enhancement object (e.g., an implicit enhancement point). As a further example, the source code statement “END of Module A” 822, which indicates the end of the source code for program module A 802, may also used be as an implicit enhancement object. As will be appreciated by those skilled in the art, these and other identifiable points or areas in the source code may be used as implicit enhancement objects. One advantage of using implicit enhancement objects is that they do not require the addition of explicit statements or identifiers (such as those referenced above for the explicit enhancement points and sections). Another advantage is that they may permit the creation and management of enhancement objects to existing software systems without the need for a developer to enter explicit statements or to otherwise modify the source code. Implicit enhancement objects may be defined and managed through files, containers or tables which are external to the core layer. Alternatively, such files, containers or tables may be made part of the core layer, but remain external or separate to the existing source code of the core.

Consistent with an aspect of the invention, enhancement spots may also be provided to facilitate enhancements to the core. An enhancement spot may be defined through the combination of one or more enhancement points and enhancement sections. Between enhancement spots, one or more enhancement objects may be common. Implicit enhancement objects may also be included in an enhancement spot. Enhancement spots may be defined and managed through files, containers or tables. Such files, containers or tables may be external to the core layer or provided as part of the core layer but separate from the source code of the core.

In FIG. 8A, two enhancement spots are illustrated: Enhancement SPOT S1 and Enhancement SPOT S2 that are defined by containers 808 and 818, respectively. By way of example, Enhancement SPOT S1 may be defined to include explicit enhancement objects, such as ENHANCEMENT-POINT P1 806, ENHANCEMENT-POINT P2 810, ENHANCEMENT-SECTION P3 812 and ENHANCEMENT-POINT P4 816. In contrast, Enhancement SPOT S2 may include ENHANCEMENT-POINT P4 816 and ENHANCEMENT-POINT P5 820. Implicit enhancements may also be included in the defined enhancement spots. For instance, as shown in FIG. 8A, Enhancement SPOT S1 includes Begin of Module A 804 and Enhancement SPOT S2 includes End of Module A 822.

Consistent with an aspect of the invention, each enhancement object may be linked or related to an enhancement implementation. This relationship may direct or indirect through the definition of enhancement spots, as explained further with respect to FIG. 8B. Enhancement implementations may be provided as part of packages or other software elements to provide the necessary functions or features selected by a user.

As will be appreciated by those skilled in the art, FIG. 8A is merely exemplary. The enhancement objects illustrated in FIG. 8A may relate to other layers of a complex software system. For example, source code containing enhancement objects may be included in any layer or part of the complex software.

Referring now to FIG. 8B, the relationship between enhancement spots and enhancement implementations will be described, consistent with an embodiment of the invention. In FIG. 8B, Enhancement SPOT S1 is shown. While the enhancement spot is illustrated as being defined by a container 808 in core layer 130, it may be located in any other layer or part of the complex software. Enhancement SPOT S1 808 may be linked to one or more enhancement implementations, which may be included as part of various software packages, such as Package 1 832 and Package N 840. By way of example, Enhancement Implementation I1 834 and Enhancement Implementation I2 836 may be included in Package 1 832. In one embodiment, unless Switch A 838 is enabled, enhancement implementations 834 and 836 may not be compiled or executed when an enhancement object related to Enhancement SPOT S1 is detected during compilation or execution of the code containing the enhancement object. By way of further example, Package N 839 may include Enhancement Implementation I3 840, whose processing (compilation and/or execution) may be controlled by Switch B 842. Although only two switches are shown in FIG. 8B, additional switches may be used.

The linking or relationship between an enhancement spot and its implementations may be provided using a file, table, or container. By way of example, FIG. 8B illustrates a table 850 containing the relationships between enhancement spots and the various enhancement implementations. As shown, table 850 may include two columns: one column 852 listing various enhancement spots and another column 854 for the various implementations corresponding to each of the enhancement spots. Thus, for example, table 850 shows three enhancement implementations corresponding to “Enhancement SPOT S1” 808. Of course, any suitable linking information or techniques, such as object oriented programming techniques, may also be used.

FIG. 8C, in accordance with another embodiment, illustrates exemplary software elements and their relationship to an enhancement implementation. In one embodiment, each enhancement implementation may have one or more instances, which may be implemented by different elements. For example, Enhancement Implementation I1 834 may have four different instances: Enhancement-Implementation-Element 1 860, Enhancement-Implementation-Element 2 862, Enhancement-Implementation-Element 3 864, and Enhancement-Implementation-Element 4 866. Each enhancement implementation element may include code, data declarations, or other types of coding that may be compiled and/or executed with the source code of the core, as discussed above with respect to FIGS. 8A and 8B.

The relationship between enhancement implementation elements and enhancement spots and related enhancement objects may be defined and managed using a file, table, or container. By way of example, FIG. 8C illustrates a table 870 shows exemplary linking between an enhancement spot, an enhancement object, an implementation of the enhancement spot, and the relevant instance of the enhancement implementation. In the exemplary embodiment of FIG. 8C, table 870 has four columns: a column listing the enhancement spots (column 872), a column listing the enhancement objects (column 874), a column listing the corresponding enhancement implementation (column 876), and a column listing the relevant instance of the enhancement implementation (column 878). Thus, for example, the automated switch framework system may, by processing table 870, compile code corresponding to element 1 implementation of “Enhancement Implementation I1” when implicit enhancement object “BEGIN of Module A” is detected during compilation of the code containing the “BEGIN CODE” statement. As will be appreciated, the linkages among these various aspects of the enhancement object implementation may be established via any relevant technique, such as object oriented programming techniques.

FIG. 8D illustrates the linkage among the various aspects discussed above, consistent with another embodiment of the invention. During compilation of source code for module A 802, ENHANCEMENT-POINT P2 may be detected. In response, the code corresponding to Enhancement Implementation Element 3 864 may be processed and compiled with the source code based on the relationships between ENHANCEMENT-POINT P2, Enhancement SPOT S1, and Enhancement Implementation I1. (This assumes, of course, if the switch corresponding to the package including the enhancement implementation is activated). Similar, processing may be performed during execution of the compiled code as well.

FIG. 8E demonstrates, in accordance with another embodiment of the invention, that complex software may have multiple levels of layers, with enhancement implementations configured in various ways. The various layers of the complex software may include, for example, the core layer 130, an extension layer including various industry solutions or extensions 880, an extension layer including solutions from business partners 882, and an extension layer including customer generated enhancements 884. Thus, for example, source code for module A 802 in core layer 130 may include an enhancement object with a link to Enhancement SPOT S2 808, which may further be implemented by at least Enhancement Implementation I1 872 located in Extension Layer 1-Industry Solutions 880, which may further link to Enhancement SPOT S2 818. Enhancement SPOT S2 818 may further link to Enhancement Implementation I2 886 in Extension Layer 2-Solutions from Partners 888, which may further link to Enhancement SPOT S3 888. Enhancement SPOT S3 888 may further link to Enhancement Implementation I3 890 in Extension Layer 3-Customer Enhancements 884.

In one embodiment, the location of an enhancement object in the core layer 130 may be defined external to core layer 130. For example, the enhancement object may be defined via an external file, an external database table or an external application. As disclosed above, such an external file may be used to define implicit enhancement objects in the core layer.

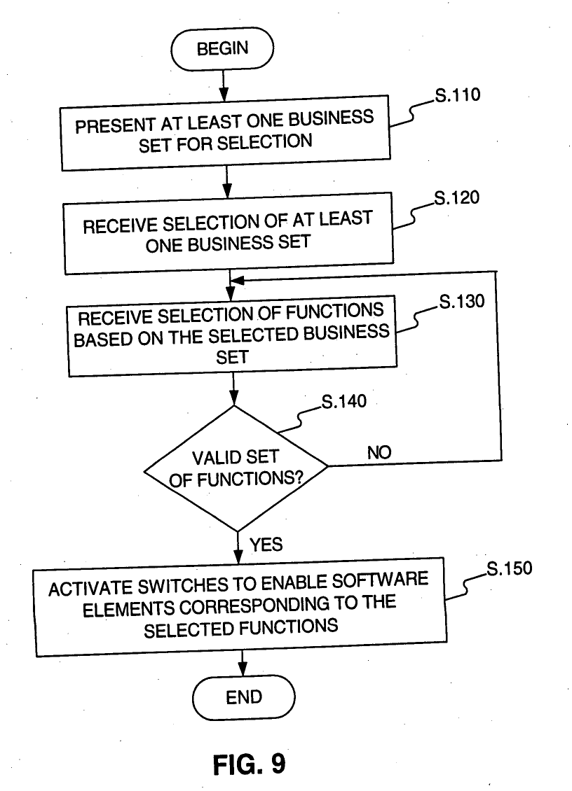

FIG. 9 is a flow chart of an exemplary method for configuring software, consistent with an embodiment of the present invention. In step S.1 10, at least one business set may be presented to the user for selection. In one embodiment, a user may be presented with options for the selection of the business set using a graphical user interface, such as interface 300 (FIG. 3) or interface 410 (FIG. 4A). Thus, the user may select a business set from groupings of industry business sets, functional business sets, or custom business sets (see, for example, FIG. 3). Alternatively, the user may be able to select a business set from a specific group of business sets, such as a business set for a group of industry business sets (see, for example, FIG. 4A).

Next, a selection of at least one business set may be received from the user (step S.120). Of course a user, may decide to select none of the business sets, in that case the process may be terminated. Once the selection of at least one business set is received, however, a selection of one or more functions based on the selected business set may be received from the user (step S.130). As part of this step, the user may be presented with a list of functions (corresponding to functionality and/or features) for selection based on the selected business set. Available selections may be presented using a graphical user interface, similar to exemplary user interface shown in FIG. 4B. One skilled in the art will appreciate that any graphical user interface and/or other techniques (e.g., email, orally via telephone, etc.) may be used to present functions for user selection.

A configuration module or similar logic may determine whether the user selection of functions is valid (step S.140). In one embodiment, this step may include detecting any conflicts among the selected functions. Conflicts may be detected by applying logic or a suitable algorithm. In one embodiment, one or more tables may be accessed that indicate permissible combinations of functions. Conflicts between selected functions may relate to, for example, incompatible or unsupported combinations of functions or logic. Invalid function selections may also arise if it is determined that any two selected functions may result in, for example, attempts to modify or call the same data or system components at substantially the same time. In one embodiment, such conflicts may be known or determined based on the analysis of various configurations of industry extensions 120, etc.

If the selection of functions is determined not to be valid (step S.140; No), then the process may return to step S.130 where the user is again prompted to make a selection. As part of this step, the user may be informed of his/her selection was determined to be invalid. Additionally, or alternatively, in one embodiment, at least one alternative or additional function may be proposed to the user, such that the conflict among the functions can be resolved by selecting that function.

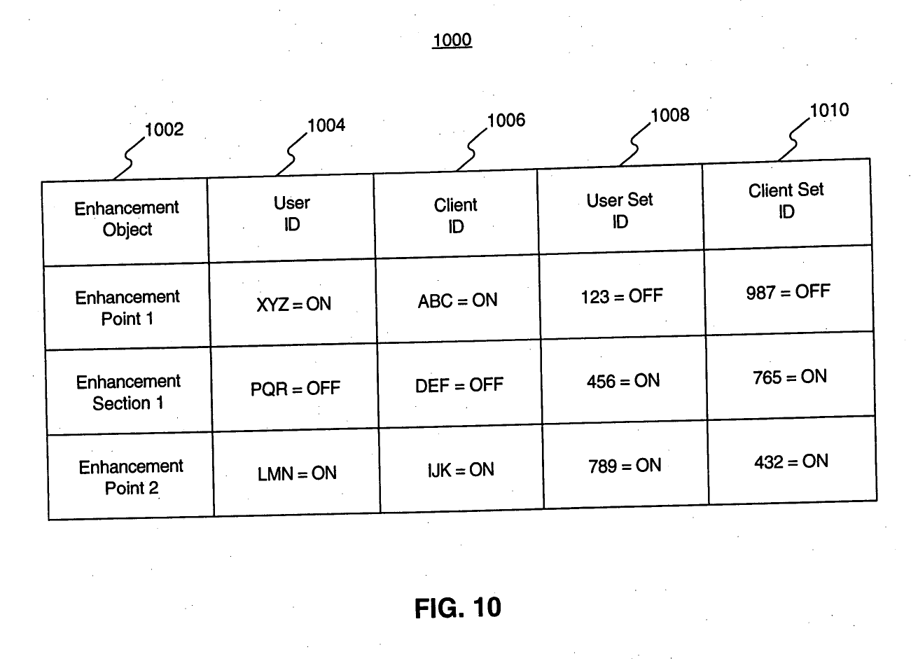

If the user selection is determined to be valid (step S.140; Yes), then processing may continue. In step S.150, a configuration module or similar logic may activate switches corresponding to the selected functions. Thus, for example, tables and/or other data storage elements may be updated to configure the switches based on the selected functions. Such updates may be made to activate software elements corresponding to the functions selected by the user. For example, with reference to FIG. 6, if the user had selected Functions 1 and 2, then Switches A, B, and C may be activated. This may involve registering the switches as being turned on in a database table. The database table for registering the status of switches corresponding to various functions may be a single dimensional table storing the one on one relationship between a function and a corresponding switch. Alternatively, or additionally, more complex relationships among switches and functions may be stored using database tables or object oriented techniques (see, e.g., FIG. 10).

FIG. 10 is a table 1000 showing exemplary relationships among various enhancement objects, users, clients, user sets, and client sets. Table 1000, which may be stored in a database or other suitable memory, may have one or more columns, such as an enhancement object column 1002, user ID column 1004, client ID column 1006, user set ID column 1008, and client set ID column 1010. Enhancement object column 1002 may list various enhancement objects, such as enhancement point 1 (e.g., as shown in FIG. 8A). User ID column 1004 may list a user ID and a status of an execution switch corresponding to the user ID. Thus, table 1000 shows that for user ID XYZ, the execution switch corresponding to enhancement spot 1 is on or activated. Client ID column 1006 may list a client ID and a status of an execution switch corresponding to the client ID. Thus, table 1000 shows that for client ID ABC, the execution switch corresponding to enhancement point 1 is on or activated. User Set ID column 1008 may list a user set ID and a status of an execution switch corresponding to the user set ID. Thus, table 1000 shows that for user set ID 123, the execution switch corresponding to enhancement point 1 is off or not activated. Any users who are part of the identified user set ID may have the execution switch corresponding to enhancement spot off accordingly. Alternatively, for some users who are part of the identified user set ID, the execution switch corresponding to the enhancement spot may be turned on individually.

Referring again to the exemplary embodiment of FIG. 10, Client Set ID column 1010 may list a client set ID and a status of an execution switch corresponding to the client set ID. Thus, table 1000 shows that for client set ID 987, the execution switch corresponding to enhancement point 1 is off or not activated. Any clients who are part of the identified client set ID may have the execution switch corresponding to enhancement spot off accordingly. Alternatively, for some clients who are part of the identified client set ID, the execution switch corresponding to the enhancement spot may be turned on individually.

Table 1000 lists additional exemplary entries for an enhancement section (see FIG. 8B, for example). As will be appreciated by those skilled in the art, table 1000 is merely exemplary, and may contain fewer or additional rows or columns, as needed. Relationships among enhancement objects and users may be organized by other means, such as object oriented techniques, and may not be limited to the ones shown in FIG. 10.

In an exemplary method for executing code corresponding to a core layer (core layer 130 of FIG. 1, for example) and code corresponding to at least one of a plurality of industry extensions, a run-time environment module (e.g., ABAP run-time environment) or another software module responsible for execution, may detect an enhancement object at a first location in the code corresponding to the core layer. In one embodiment, upon detecting the enhancement object, the run-time environment module may switch execution from the first location to a second location relating to one of the plurality of industry extensions. Additionally, or alternatively, the run-time environment module may switch execution only when an execution switch corresponding to the enhancement object is activated or turned on. Run-time environment module may determine this by examining a database table (e.g., table 1000 of FIG. 10 or another table), which may store relationships between enhancement objects and switches.

Run-time environment module or similar logic may then determine whether the enhancement object is an enhancement point type of object. If the enhancement object is an enhancement point type of object, then run time environment module or similar logic may execute code corresponding to a code block at the second location along with the code corresponding to the core layer. If, however, the enhancement object is not an enhancement point type of object, then run time environment module or similar logic may execute the code corresponding to the code block at the second location instead of at least a part of the code corresponding to the core layer. Thus, consistent with one embodiment, an enhancement object may be of two types: either an enhancement point type of object or an enhancement section type of object (see, e.g., FIG. 8A). Alternatively, or additionally, other types of enhancement objects may also be used.

In one embodiment, once a user selects a function corresponding to a business set, that function may relate to an enhancement object (e.g., enhancement objects of FIG. 8A). Furthermore, the selection of the function by the user may also result in activation of an execution switch corresponding to the code block. By way of a non-limiting example, during execution, the code corresponding to the code block may only be executed when the execution switch corresponding to the code block is activated. In addition, the user may also select a plurality of functions, and in that case a plurality of execution switches corresponding to a plurality of code blocks may be activated. In one embodiment, as shown in table 1000 (FIG. 10), the plurality of execution switches may relate to a user, a client, a set of users, and/or a set of clients. Run-time environment module may process table 1000 to determine proper execution of code corresponding to various code blocks.

In another exemplary method for executing code corresponding to a core layer (130 of FIG. 1, for example) and code corresponding to at least another software element, a run-time environment module (e.g., an ABAP run-time environment) or another software module responsible for execution, may detect an enhancement object at a first location in the code corresponding to the core layer. Detecting the enhancement object at the first location may include checking an external file. In one embodiment, upon detecting the enhancement object, the run-time environment module may switch execution from the first location to a second location in code outside the core layer. Thus, for example, the run-time environment module may switch execution to code corresponding to another software element. Additionally, or alternatively, the run-time environment module may switch execution only when an execution switch corresponding to the enhancement object or software element is activated or turned on. Run-time environment module may determine this by examining a database table (e.g., table 1000 of FIG. 10 or another table), which may store relationships between enhancement objects and switches.

Thus, if the enhancement object is an enhancement point type of object, then run time environment module or similar logic may execute code corresponding to a code block at the second location along with the code of the core layer. If, however, the enhancement object is not an enhancement point type of object, then run time environment module or similar logic may execute the code corresponding to the code block at the second location instead of at least a part of the code corresponding to the core layer.

Processing of code corresponding to various code bocks may result in conflicts. In one embodiment, some conflicts among user-selected functions may be resolved using a combination of switches. Thus, for example, where a user selects two functions, which may attempt to redefine the same object and/or attempt to modify the same code, an alternative set of code may be activated when both functions are activated by the user. In other words, if only one function (e.g., F1) is activated then the switch (e.g., SW1) corresponding to that function may be activated. Similarly, when another function (e.g., F2), but not function F1, is activated then the switch (e.g., SW2) corresponding to the second function may be activated. But, when both functions are activated, then a combination switch (SW3=SW1 AND SW2) may be activated and the alternative set of code that resolves the conflict may be processed.

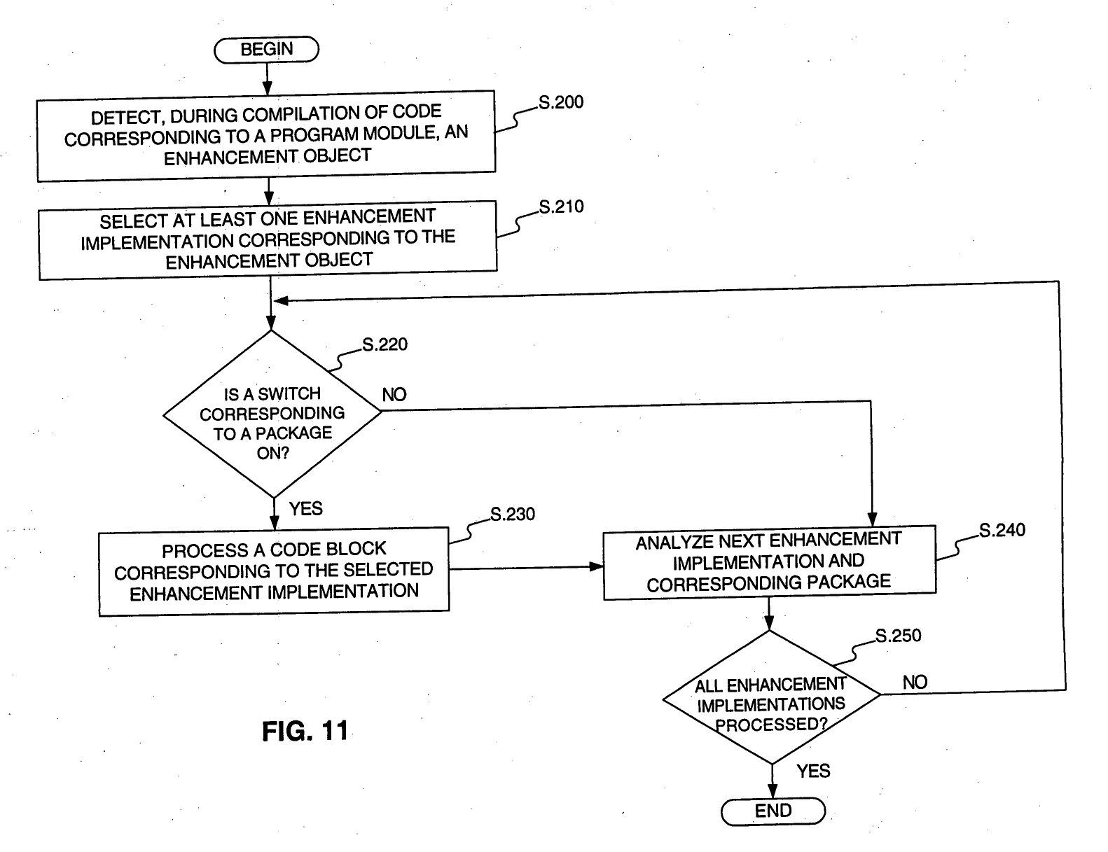

FIG. 11 shows an exemplary method for compiling and generating complex software, consistent with another embodiment of the invention. As shown, in step S.200, a software module, such as an automated switch framework module may detect, during compilation of code corresponding to a program module, an enhancement object. As disclosed herein, the code corresponding to the program module may reside in any layer of the complex software. Next, the automated switch framework module may select at least one enhancement implementation corresponding to the enhancement object (step S.210). In one embodiment, the selection of the enhancement implementation may be made based on the linkages or relationships, as explained with respect to FIGS. 8A-E. Next, the automated switch framework module may determine whether a switch corresponding to the package including the enhancement implementation is on (step S.220). If yes, the code block corresponding to the selected enhancement implementation may be processed and appropriately compiled (step S.230). If not (or after processing of step S.230 is complete), the automated switch framework module may analyze the next enhancement implementation and corresponding package (step S.240). As part of this step, a code block corresponding to the selected enhancement implementation may be processed. Thus, for example, with respect to FIG. 8B, the automated switch framework module may process Enhancement Implementation I1 834 and Enhancement Implementation I2 836 corresponding to enhancement object Enhancement SPOT S1 808 if Switch A 838 is on. Next, automated switch framework module may determine whether all enhancement implementations corresponding to the enhancement object have been processed (step S.250). If yes, then the compilation and/or execution of the remaining code of the program module may continue. If not, then the automated switch framework module may check whether any enhancement implementations corresponding to a different package need to be processed depending on the switch setting for that package.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules can be integrated in existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

As disclosed herein, embodiments and features of the invention may be implemented through computer-hardware and/or software. Such embodiments may be implemented in various environments, such as networked and computing-based environments with one or more users. The present invention, however, is not limited to such examples, and embodiments of the invention may be implemented with other platforms and in other environments.

By way of example, embodiments of the invention may be implemented using conventional personal computers (PCs), desktops, hand-held devices, multiprocessor computers, pen computers, microprocessor-based or programmable consumer electronics devices, minicomputers, mainframe computers, personal mobile computing devices, mobile phones, portable or stationary personal computers, palmtop computers or the like.

The storage mediums and databases referred to herein symbolize elements that temporarily or permanently store data and instructions. Although storage functions may be provided as part of a computer, memory functions can also be implemented in a network, processors (e.g., cache, register), or elsewhere. While examples of databases have been provided herein, various types of storage mediums can be used to implement features of the invention, such as a read only memory (ROM), a random access memory (RAM), or a memory with other access options. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM), or a digital versatile disk (DVD); (c) semiconductor media, like DRAM, SRAM, EPROM, EEPROM, memory stick, and/or by any other media, like paper.

Embodiments of the invention may also be embodied in computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, intranets and the Internet (i.e., the World Wide Web). The network can be a wired or a wireless network. To name a few network implementations, the network is, for example, a local area network (LAN), a wide area network (WAN), a public switched telephone network (PSTN), an Integrated Services Digital Network (ISDN), an infra-red (IR) link, a radio link, such as a Universal Mobile Telecommunications System (UMTS), Global System for Mobile Communication (GSM), Code Division Multiple Access (CDMA), or a satellite link.

While certain features and embodiments of the invention have been described, other embodiments of the invention will be apparent to those skilled in the art from consideration of the specification and practice of the embodiments of the invention disclosed herein. Further, the steps of the disclosed methods may be modified in any manner, including by reordering steps and/or inserting or deleting steps, without departing from the principles of the invention.

It is therefore intended that the specification and examples be considered as exemplary only, with a true scope and spirit of the invention being indicated by the following claims.

What is claimed is:

1. A method for executing complex software, the complex software comprising code corresponding to a core layer and code corresponding to at least one of a plurality of industry extensions, the method comprising:
detecting, during execution of the code corresponding to the core layer, an enhancement object at a first location, wherein the enhancement object relates to one of the plurality of industry extensions;
switching execution from the first location to a second location in the code relating to the one of the plurality of industry extensions; and
depending on a type of the enhancement object, executing code corresponding to a code block at the second location along with the code corresponding to the core layer, or executing the code corresponding to the code block at the second location instead of at least a part of the code of the core layer.

2. The method of claim 1, wherein the code at the second location relates to a code block corresponding to a function selected by a user.

3. The method of claim 2, wherein the selection of the function by the user results in an activation of a switch corresponding to the code block.

4. The method of claim 3, wherein the code corresponding to the code block is executed only when the switch corresponding to the code block is activated.

5. The method of claim 2, wherein the user selection is stored in a database table.

6. The method of claim 1, further comprising activating a plurality of switches for a plurality of code blocks corresponding to a plurality of functions selected by a user.

7. The method of claim 6, wherein at least one of the plurality of switches relates to one from the group comprising a user, a client, a set of users, and a set of clients.

8. The method of claim 6, wherein the user selection is stored in a database table.

9. A system for executing code corresponding to a core layer and code corresponding to at least one of a plurality of industry extensions, the system comprising:
means for detecting an enhancement object at a first location, during execution of the code corresponding to the core layer, wherein the enhancement object relates to the one of the plurality of industry extensions;
means for switching execution from the first location to a second location in the code relating to one of the plurality of industry extensions; and
means for, depending on a type of the enhancement object, either executing code corresponding to a code block at the second location along with the code corresponding to the core layer, or executing the code corresponding to the code block at the second location instead of at least a part of the code corresponding to the core layer.

10. The system of claim 9, wherein the code at the second location relates to a code block corresponding to a function selected by a user.

11. The system of claim 10, wherein the selection of the function by the user results in an activation of a switch corresponding to the code block.

12. The system of claim 11, wherein the code corresponding to the code block is executed only when the switch corresponding to the code block is activated.

13. The system of claim 10, wherein the user selection is stored in a database table.

14. The system of claim 9 further comprising means for activating a plurality of switches for a plurality of code blocks corresponding to a plurality of functions selected by a user.

15. The system of claim 14, wherein at least one of the plurality of switches relates to one from the group comprising a user, a client, a set of users, or a set of clients.

16. The system of claim 14, wherein the user selection is stored in a database table.

17. A method for executing complex software, the complex software including code corresponding to a core layer and code provided outside the core layer, the method comprising:
detecting, during execution of the code corresponding to the core layer, an enhancement object at a first location, wherein detecting the enhancement object at the first location comprises checking an external file;
switching execution from the first location to a second location in code outside the core layer; and
depending on a type of the enhancement object, executing code corresponding to a code block at the second location along with the code corresponding to the core layer, or executing the code corresponding to the code block at the second location instead of at least a part of the code of the core layer.

18. The method of claim 17, wherein the code at the second location relates to a code block corresponding to a function selected by a user.

19. The method of claim 18, wherein the selection of the function by the user results in an activation of a switch corresponding to the code block.

20. The method of claim 19, wherein the code corresponding to the code block is executed only when the switch corresponding to the code block is activated.

21. The method of claim 18, wherein the user selection is stored in a database table.

22. The method of claim 17, further comprising activating a plurality of switches for a plurality of code blocks corresponding to a plurality of functions selected by a user.

23. The method of claim 22, wherein at least one of the plurality of switches relates to one from the group comprising a user, a client, a set of users, and a set of clients.

24. The method of claim 22, wherein the user selection is stored in a database table.

25. A system for executing code corresponding to a core layer and code provided external to the core layer, the system comprising:
means for detecting, during execution of the code corresponding to the core layer, an enhancement object at a first location, wherein the means for detecting the enhancement object at the first location comprises means for checking an external file;
means for switching execution from the first location to a second location in code outside the core layer; and
means for, depending on a type of the enhancement object, either executing code corresponding to a code block at the second location along with the code corresponding to the core layer, or executing the code corresponding to the code block at the second location instead of at least a part of the code of the core layer.

26. The system of claim 25, wherein the code at the second location relates to a code block corresponding to a function selected by a user.

27. The system of claim 26, wherein the selection of the function by the user results in an activation of a switch corresponding to the code block.

28. The system of claim 27, wherein the code corresponding to the code block is executed only when the switch corresponding to the code block is activated.

29. The system of claim 26, wherein the user selection is stored in a database table.

30. The system of claim 25, further comprising means for activating a plurality of switches for a plurality of code blocks corresponding to a plurality of functions selected by a user.

31. The system of claim 30, wherein at least one of the plurality of switches relates to one from the group comprising a user, a client, a set of users, and a set of clients.

32. The system of claim 30, wherein the user selection is stored in a database table.

33. A method for generating complex software, the complex software including core layer code, the method comprising:
detecting, during compilation of the core layer code, an enhancement object;
selecting enhancement implementations corresponding to the enhancement object; and
for each of the selected enhancement implementations:
determining a status of a switch corresponding to a software package; and
depending on the status of the switch processing a code block corresponding to at least one of the selected enhancement implementations.
